(19) United States
(12) Patent Application Publication
(10) Pub. No.: US 2018/0268402 A1
(43) Pub. Date: Sep. 20, 2018

(54) Dynamically Passing Authentication Information Across Devices

(71) Applicant: Motorola Mobility LLC, Chicago, IL (US)

(72) Inventors: Amit Kumar Agrawal, Bangalore (IN); Satyabrata Rout, Bangalore (IN)

(73) Assignee: Motorola Mobility LLC, Chicago, IL (US)

(21) Appl. No.: 15/805,040

(22) Filed: Nov. 6, 2017

(30) Foreign Application Priority Data
Mar. 15, 2017 (IN) 201731008986

(51) Int. Cl. G06Q 20/38; H04L 29/06; G06Q 20/08; G06Q 20/32; G06Q 20/40

(52) U.S. Cl. CPC G06Q 20/385; H04L 63/0838; G06Q 20/40145; G06Q 20/0855; G06Q 20/327; H04L 63/0861

(57) ABSTRACT

Various embodiments dynamically transfer authentication information between devices. A first computing device establishes a first communication link with a second computing device, and a second communication link with a remote computing device. Upon accessing the remote computing device over the second communication link, the first computing device receives a request for authentication information from the remote computing device. In turn, the first computing device queries the second computing device for the authentication information over the first communication link. Before sending the authentication information, the second computing device prompts a user for credentials to validate the request for authentication information. Responsive to receiving the credentials, the second computing device dynamically transfers the authentication information to the first computing device over the first communication link. Upon receiving the authentication information, some embodiments auto-populate a user interface with the authentication information to unburden the user of entering input including the authentication information.

### RELATED APPLICATION

The application claims priority under 35 U.S.C. 119 or 365 to Indian Application No. 201731008986, filed Mar. 15, 2017, the disclosure of which is incorporated in its entirety.

### BACKGROUND

Communication networks, such as the Internet, allow various devices to share data remotely with one another. While this can be a powerful tool, it can also put a user at risk. For example, these communication networks oftentimes provide remote users with access to databases that store sensitive information. If these databases have insecure or inadequate protection over the sensitive information, hackers can easily circumvent the security measures and gain access to the sensitive information. To increase security, data protection has evolved into a more complex process. For example, some data protection processes involve multiple steps that use multiple computing devices. While these more complex security measures deliver added protection, they oftentimes add extra burden to the user. The multi-step multi-device process can be especially cumbersome when the user repeatedly performs these steps. Some third-party payment websites provide data protection to the sensitive information stored at the third-party website by obscuring the sensitive information from other users and/or websites. However, these third-party payment websites force the user to store sensitive information outside of the user's immediate control, which may be uncomfortable to the user.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an overview of a representative environment that includes an example implementation in accordance with one or more embodiments;

FIG. 2 illustrates a more detailed view of an example implementation included in FIG. 1 in accordance with one or more embodiments;

FIG. 3 illustrates a more detailed view of an example implementation included in FIG. 1 in accordance with one or more embodiments;

FIGS. 4a and 4b illustrate example scenarios in which one or more embodiments can be employed;

FIG. 5 illustrates a flow diagram in which dynamic transfer of authentication information between devices is employed in accordance with one or more embodiments;

FIG. 6 illustrates a flow diagram in which dynamic transfer of user information between devices is employed in accordance with one or more embodiments;

FIGS. 7 illustrates an example user interface in accordance with one or more embodiments;

FIG. 8 is an illustration of an example device in accordance with one or more embodiments; and

FIG. 9 is an illustration of an example device in accordance with one or more embodiments.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

Various embodiments dynamically transfer authentication information between devices. A first computing device establishes a first communication link with a second computing device, and a second communication link with a remote computing device. Upon accessing the remote computing device over the second communication link, the first computing device receives a request for authentication information from the remote computing device. In turn, the first computing device queries the second computing device for the authentication information over the first communication link. Before sending the authentication information, the second computing device prompts a user for credentials to validate the request for authentication information. Responsive to receiving the credentials, the second computing device dynamically transfers the authentication information to the first computing device over the first communication link. Upon receiving the authentication information, some embodiments auto-populate a user interface with the authentication information to unburden the user of entering input including the authentication information.

Some embodiments provide secure transfer of user information between devices. To facilitate an online transaction, a first computing device queries a second computing device for user information. Responsive to receiving the query, the second computing device prompts a user for credentials to validate access to user information stored on a local database. Upon receiving credentials, the second computing device displays a user interface that allow access to the user information. Responsive to selection of a particular set of user information, some embodiments transmit the particular set of user information to the first computing device. In turn, the first computing device auto-populates a user interface with the user information to unburden the user of manually entering the particular set of user information into the user interface, and enable completion of the online transaction.

Consider now an example environment in which various aspects as described herein can be employed.

Example Environment

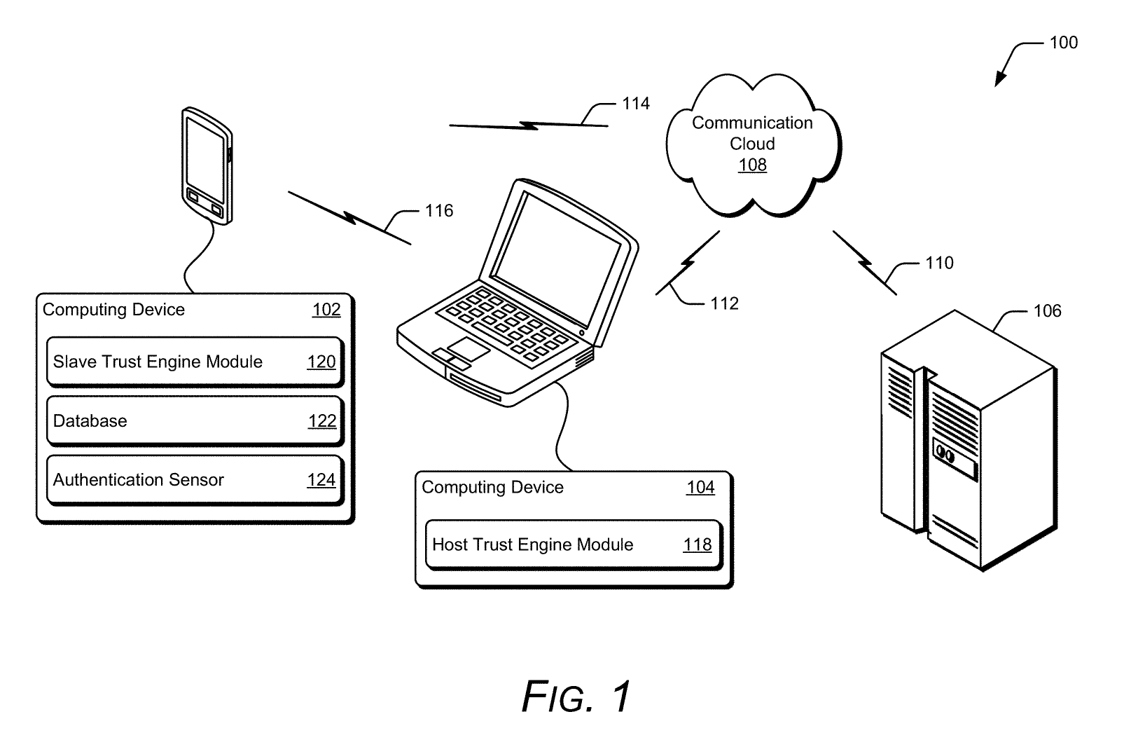

FIG. 1 illustrates an example environment 100 in accordance with one or more embodiments. Environment 100 includes computing device 102 (in the form of a mobile phone device), computing device 104 (in the form of a laptop computer), and server 106. While illustrated here as a mobile device, laptop computer, and server, it is to be appreciated that computing device 102, computing device 104, and/or server 106 can be any other suitable type of computing device without departing from the scope of the claimed subject matter.

Environment 100 includes communication cloud 108, which generally represents any suitable type of communication network that facilitates a bi-directional link between various computing devices, and represents any suitable type of communication network. Communication cloud 108 can include multiple interconnected communication networks that comprise a plurality of interconnected elements, such as a wireless local area network (WLAN) with Ethernet access, a wireless telecommunication network interconnected with the Internet, a wireless (Wi-Fi) access point connected to the Internet, and so forth. In this example, communication cloud 108 connects into server 106 by way of communication link 110, into computing device 104 by way of communication link 112, and computing device 102 by way of communication link 114. Thus, server 106 and computing device 104 communicate with one another through communication cloud 108 using communication link 110 and communication link 112. In a similar manner, server 106 and computing device 102 communicate with one another through communication cloud 108 using communication link 110 and communication link 114. These communication links can be used to exchange any suitable type of data and/or information. For instance, computing device 104 can use communication link 112 and communication link 110 to access a web site hosted by server 106, such as an email account, a shopping website, a social media website, and so forth. As another example, server 106 can communication authentication information to computing device 102 over communication cloud 108 using communication link 110 and communication link 114.

In some embodiments, computing device 104 and computing device 102 communicate with one another via communication cloud 108 using communication link 112 and communication link 114. Alternately or additionally, computing device 104 and computing device 102 can communicate with one another using a separate communication link 116 that is outside of communication cloud 108. Here, communication link 116 generally represents any suitable protocol, system, or other vehicle used to exchange data between devices. In some embodiments, communication link 116 represents a local communication link, such as a Bluetooth™ wireless link, an infrared wireless communication link, a direct cable connection between devices, and so forth. In other embodiments, communication link 116 represents a link that uses a communication system that spans outside of a local environment, such as a cellular wireless link, and/or communication cloud 108. Thus, computing device 102 and computing device 104 can exchange data using a communication link that outside of communication cloud 108, communication link 112, and communication link 114. In some embodiments, communication link 116 uses an encrypted channel to protect data transferred between computing device 102 and computing device 104.

Computing device 104 includes host trust engine module 118 that is used to synchronize with computing device 102, and exchange data over communication link 116. For example, as computing device 104 accesses server 106, such as through a website hosted by server 106, server 106 may request additional information from computing device 104 that is stored on computing device 102. This can include, by way of example and not of limitation, authentication information and/or user information as further described herein. In turn, computing device 104 uses host trust engine module 118 to query computing device 102 for the information. With respect to computing device 102 and computing device 104, the request for information originates from computing device 104. Accordingly, computing device 104 can be considered a host device or originating device in this exchange. Thus, the phrase “host” as used herein indicates a device in an exchange between devices that initiates actions and/or originates requests. In turn, the phrase “slave” as utilized herein indicates a device in an exchange between devices that responds to the requests. Accordingly, computing device 104 includes host trust engine module 118 to initiate requests for information from computing device 102. Upon receiving the requested information from computing device 102, some embodiments of host trust engine module 118 auto-populate fields of a user interface with the requested information to unburden a user from manually entering the information in the fields, such as fields of the website hosted by server 106. When the fields of the user interface have been populated, computing device 104 can automatically submit the information to server 106, or display a prompt to the user and wait for a confirmation before submitting the information to server 106.

Computing device 102 includes slave trust engine module 120 and database 122. Among other things, slave trust engine module 120 is used to synchronize communications between computing device 102 and computing device 104. Alternately or additionally, slave trust engine module 120 processes incoming communications from computing device 104 via communication link 116, such as a request for authentication information and/or user information stored in database 122. Sometimes slave trust engine module 120 receives information from server 106 via communication cloud 108, such as authentication information from server 106, and manages access to that information. As one example, server 106 can transmit authentication information in the form of a One-Time Password (OTP) to computing device 102 over communication cloud 108. In turn, computing device 104 may request the OTP from computing device 102 over communication link 116. Thus, some embodiments of slave trust engine module 120 manage receiving information from various sources over a first communication link, and the subsequent distribution of this information over a second communication link. As another example, some embodiments of slave trust engine module 120 manage user access to information stored in database 122, and the subsequent distribution of the stored information. In either example, slave trust engine module 120 can gate access to information, whether received from an external source or stored in a local database, based upon verifying a user's credentials. Any suitable form of credentials can be utilized. For instance, slave trust engine module 120 can grant access to information upon validating biometric credentials of a user (e.g., fingerprint, eye print, etc.), or alternately grant access based upon a passcode or log-in information. Upon validating a user's credentials, some embodiments enable selection of a particular set of information, and/or transfer information to computing device 104 via synchronized communications with host trust engine module 118 over communication link 116.

Database 122 represents secure storage on computing device 102. In some embodiments, database 122 includes multiple different types of user information, such as financial information, savings or checking bank account information, passwords and/or user names, credit card information, debit card information, gift card information, pre-paid card information, Personal Identification Number (PINs), and so forth. In order to access database 122, various embodiments first validate credentials associated with a user as further described herein.

Computing device 102 includes authentication sensor 124 that represents functionality for authenticating credentials and/or authentication of a user. In some embodiments, authentication sensor 124 includes hardware sensors that gather data used to authenticate biometric credentials such as, by way of example and not of limitation, a camera for facial recognition, a sensor to identify fingerprints, an eye sensor, and so forth. In some embodiments, authentication sensor 124 includes a finger print sensor (FPS) that scans and/or gathers information used to identify a fingerprint that is touching a portion of the sensor. While described in the context of a hardware sensor, it is to be appreciated that authentication sensor 124 can alternately or additionally include software, firmware, hardware, or any combination thereof. For example, authentication sensor 124 can include software that interfaces with slave trust engine module 120 to exchange data and/or credential information. This can simply be a notification that credentials have been positively (or negatively) validated, or can be more complex, such as data gathered from the sensor that is subsequently used by slave trust engine module 120 to extract credential information. Here, a credential is positively validated when the credential is associated with a known user (e.g., a fingerprint is recognized as a known fingerprint of a valid user), and negatively validated when the credential is unknown, not recognized, and/or has no association with a known user. In various embodiments, positive validation of a credential grants access to information, while negative validation of a credential denies access to the information.

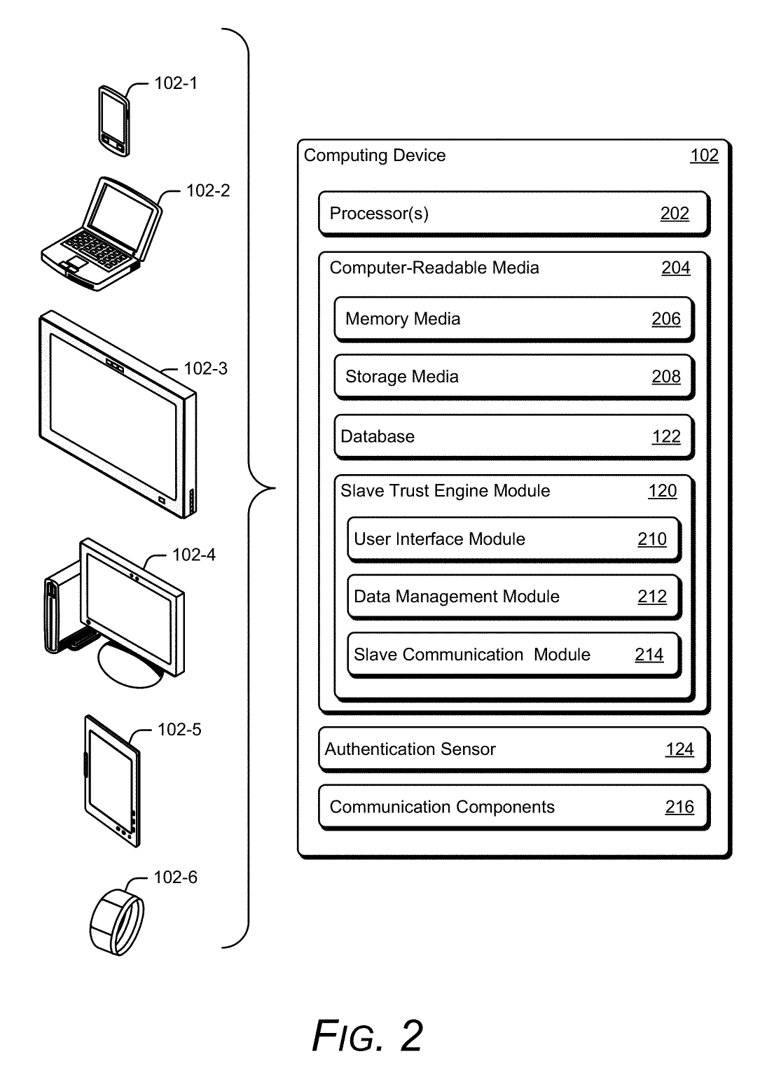

FIG. 2 illustrates an expanded view of computing device 102 of FIG. 1 with various non-limiting example devices including: smartphone 102-1, laptop 102-2, television 102-3, desktop 102-4, tablet 102-5, and smart watch 102-6. Accordingly, computing device 102 is representative of any suitable device that incorporates dynamic transfer of information between devices by way of slave trust engine module 120. Computing device 102 includes processor(s) 202 and computer-readable media 204, which includes memory media 206 and storage media 208. Applications and/or an operating system (not shown) embodied as computer-readable instructions on computer-readable media 204 are executable by processor(s) 202 to provide some, or all, of the functionalities described herein. For example, various embodiments can access an operating system module, which provides high-level access to underlying hardware functionality by obscuring implementation details from a calling program, such as protocol messaging, register configuration, memory access, and so forth.

Computer-readable media 204 includes database 122 and slave trust engine module 120 of FIG. 1. While slave trust engine module 120 and database 122 are illustrated here as residing on computer-readable media 204, they can alternately or additionally be implemented using hardware, firmware, software, or any combination thereof.

Slave trust engine module 120 includes user interface module 210, data management module 212, and slave communication module 214. In some embodiments, user interface module 210 provides access to data stored in database 122, such as a user interface with selectable controls to navigate and select a particular set of data. In some cases, user interface module 210 displays a prompt or query to a user to allow or deny access to data stored in database 122.

While user interface module 210 presents access to data, data management module 212 supervises data distribution (e.g., incoming requests for data, incoming data input, outgoing data, verifying data access, etc.). For instance, data management module 212 can receive incoming authentication information, such as authentication information from server 106 of FIG. 1, and redirect the authentication information to a destination device, such as computing device 104 of FIG. 1. Data management module 212 interprets incoming requests for data, and conditionally returns the requested data based upon whether the supplied credentials have authorization to confirm the request. In some embodiments, credentials are based upon validating a user identification, such as through biometric authentication and/or login information. In order to accomplish this, some embodiments of data management module 212 interface with authentication sensor 124 and/or communication components 216.

Slave communication module 214 represents functionality that performs synchronized communication with another device. For example, slave communication module 214 includes functionality that receives and interprets messages from a host communication module. In turn, slave communication module 214 passes the messages to data management module 212 for processing. Slave communication module 214 can also include any message and/or protocol handshaking used to exchange messages between a host communication module and a slave communication module. Here, messaging is considered to be at a higher level than hardware management of communication. In other words, slave communication module understands and returns the appropriate handshaking messages between the communication modules, but does not manage the physical hardware used to send the messages.

Computing device 102 includes authentication sensor 124 and communication components 216. Here, authentication sensor 124 represents functionality that authenticates an identity of a user, such as, by way of example and not of limitation, a camera for facial recognition, a sensor to identify fingerprints, an eye sensor, and so forth. Communication components 216 represent functionality that enables computing device 102 to physically transmit data to, and receive data from, external devices, such as an input/output port or a transceiver chain. Some portions of communication components 216 perform signal and/or protocol processing to implement data transfer via communication link 114 of FIG. 1, while other portions of communication components 216 perform signal and/or protocol processing to perform data transfer via communication link 116 of FIG. 1. While authentication sensor 124 and communication components 216 are illustrated here as single components, each can be implement as varying combinations of hardware, firmware, and/or software. For instance, in some embodiments, authentication sensor 124 and/or communication components 216 comprise hardware that includes embedded firmware. Alternately or additionally, hardware components of authentication sensor 124 and/or communication components 216 can couple to a software driver that an application interfaces with in order to access functionality provided by the hardware. In one example, slave communication module 214 determines the content of a message, and then interfaces with communication components 216 to physically transport the message to another device.

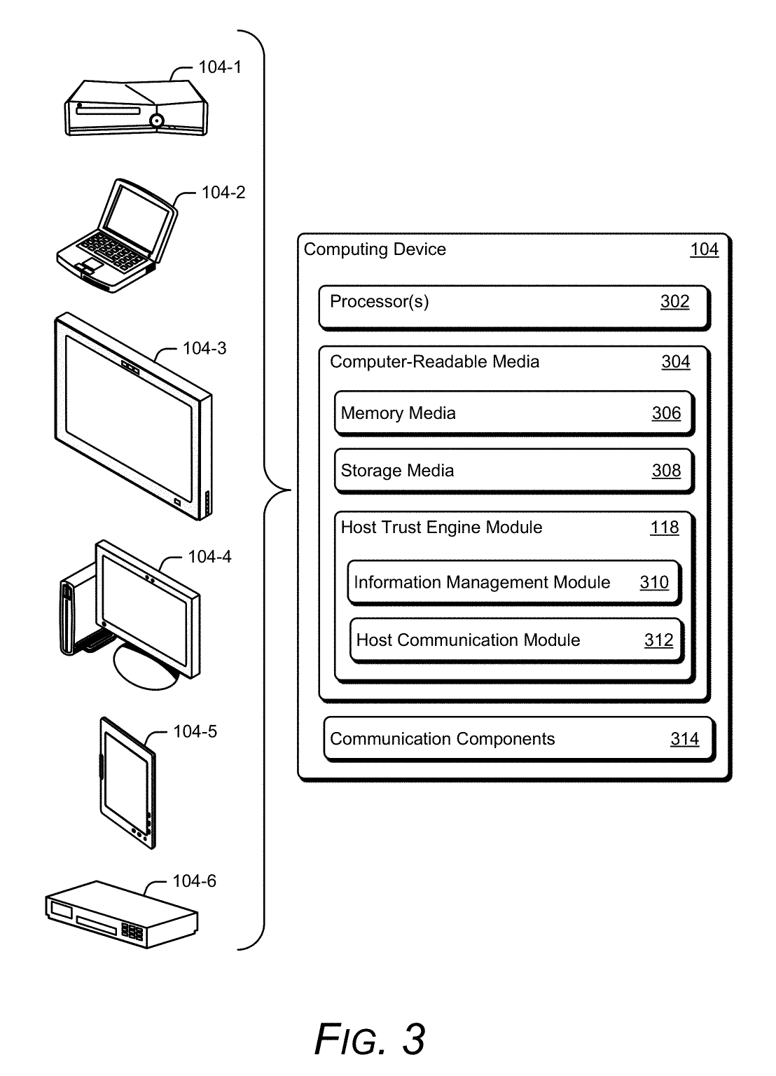

FIG. 3 illustrates an expanded view of computing device 104 of FIG. 1 with various non-limiting example devices including: gaming console 104-1, laptop 104-2, television 104-3, desktop 104-4, tablet 104-5, and set top-box 104-6. Computing device 104 includes processor(s) 302 and computer-readable media 304, which includes memory media 306 and storage media 308. Applications and/or an operating system (not shown) embodied as computer-readable instructions on computer-readable media 304 are executable by processor(s) 302 to provide some, or all, of the functionalities described herein. For example, various embodiments can access an operating system module, which provides high-level access to underlying hardware functionality by obscuring implementation details from a calling program, such as protocol messaging, register configuration, memory access, and so forth.

Computer-readable media 304 includes host trust engine module 118 of FIG. 1. While host trust engine module 118 is illustrated here as residing on computer-readable media 304, it can alternately or additionally be implemented using hardware, firmware, software, or any combination thereof.

Host trust engine module 118 includes information management module 310 and host communication module 312. Information management module 310 identifies when an application or website is requesting additional information (e.g., authentication information, an OTP, user information, etc.), and initiates communication with a second device to obtain the requested additional information. In order to accomplish this, some embodiments of information management module 310 interface with host communication module 312. Host communication module 312 represents functionality that performs synchronized communication with a counterpart, such as slave communication module 214 of FIG. 2. Here, host communication module 312 is a logical communication module in that it has high-level knowledge of what type of message needs to be sent in response to a request, what time of message is sent as a query, and so forth. However, in order to transmit messages from computing device to another device, a physical layer is used as well. Thus, computing device 104 also includes communication components 314. As in the case of slave communication module 214 of FIG. 2, host communication module determines the content of a message, and then interfaces with communication components 314 to physically transport the message to another device.

Communication components 314 represent functionality that enables computing device 104 to physical transmit data to, and receive data from, external devices. For example, some portions of communication components 314 perform signal and/or protocol processing to implement data transfer via communication link 112 of FIG. 1, while other portions of communication components 314 perform signal and/or protocol processing to perform data transfer via communication link 116 of FIG. 1. While communication components 314 is illustrated here as a single component, it can alternately or additionally be implement as hardware, firmware, software, or any varying combination thereof. For instance, in some embodiments, communication components 314 comprise hardware with embedded firmware. Alternately or additionally, hardware components of communication components 314 can couple to a software driver that an application interfaces with in order to access functionality provided by the hardware.

Having described an example operating environment in which various embodiments can be utilized, consider now of dynamic transfer of authentication information between devices in accordance with one or more embodiments.

Dynamically Passing Authentication Information

The interconnectivity of devices today allows a user freedom to access vast quantities of data remote from the user, but it additionally puts that data at risk. Not only does the user have access to the remote data, but so, too, do undesirable users (e.g., hackers). Thus, as access across devices becomes simplified, it additional becomes desirable to increase the data protection. This sometimes translates into applying complex processes to protect the data, such as a multi-step process using multiple devices. As one example, a user may first log into an account or website using a first device and a corresponding username and password. Next, the account or website might request additional authentication information, which is sent to a secondary computing device of the user. In turn, the user retrieves the additional authentication information from the secondary computing device, and then manually enters it into account or web site using the first device. Once the security system validates the user has entered the proper information, the security system grants the user access. While this multi-step process helps protect a system and its data from unintended or unauthorized access, it can be cumbersome to the user, especially when performed repeatedly.

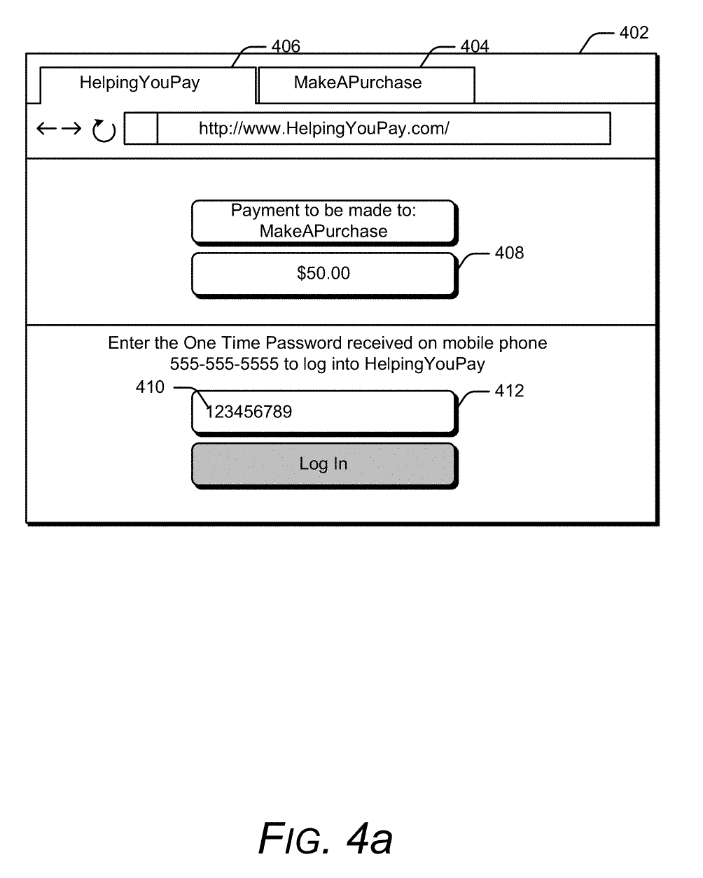

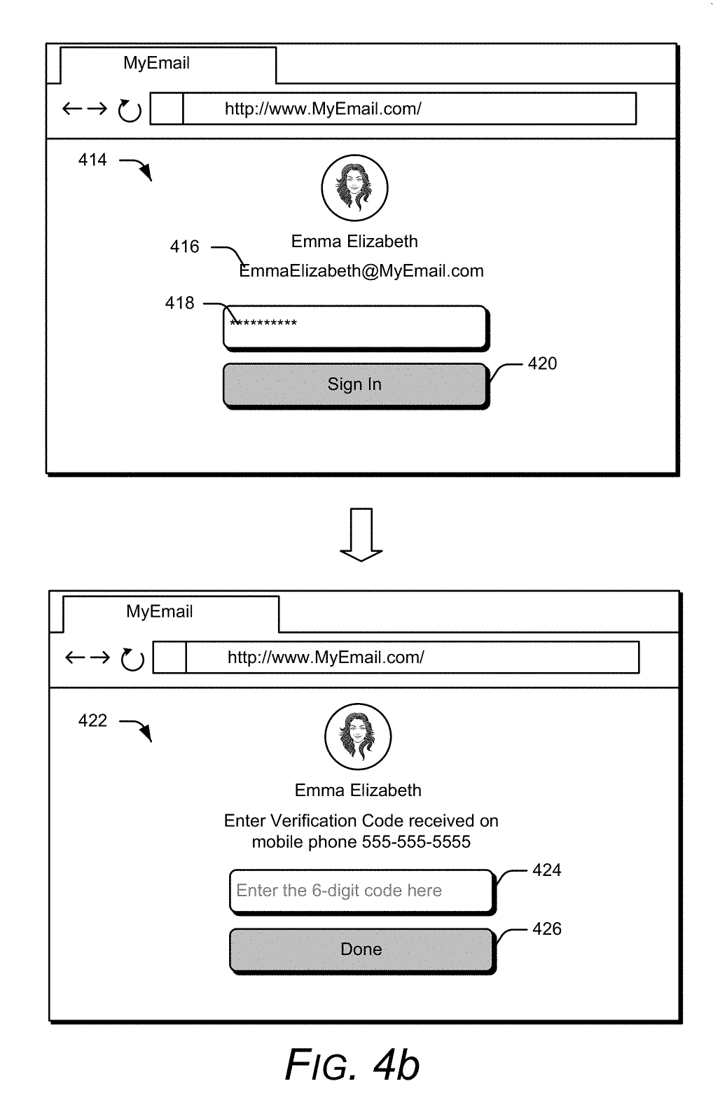

To further illustrate, consider FIG. 4a that includes a multi-tab browser 402. Here, multi-tab browser 402 allows a user to access multiple websites via separate tabs. In tab 404, a user has accessed a website entitled “MakeAPurchase”. While navigating through “MakeAPurchase”, the user has identified items to buy, and subsequently desires to make an online transaction with MakeAPurchase. However, instead of directly entering payment information into MakeAPurchase, the user has instead navigated to a third-party payment website entitled “HelpingYouPay” in tab 406. Here, “HelpingYouPay” provides the user with a way to obscure payment and/or user information from other websites. Instead entering payment information into each website the user wishes to make a transaction with, the user creates a user profile on “HelpingYouPay”, and adds the payment and/or user information to the profile (e.g., financial information, banking information, credit card information, debit card information, gift card information, PINs). When other websites, such as MakeAPurchase, support payment via HelpingYouPay, the user can alternately log onto HelpingYouPay and transfer payment without exposing sensitive user information to the seller.

Continuing on with this example, assume the user has logged into HelpingYouPay and is in the process of transferring a payment 408 to MakeAPurchase in the amount of $50.00. To add extra protection to this online transaction, HelpingYouPay has added an extra layer of authentication in the form of an OTP. In some instances, HelpingYouPay accesses the user profile to identify a secondary computing device associated with the user (e.g., a mobile phone), and transmits the OTP to that secondary computing device. This can be achieved in any suitable manner, such as through an email and/or a Short Message Service (SMS) text message. In turn, the user retrieves the information off the secondary phone, and enters OTP 410 into field 412 to complete logging into HelpingYouPay and/or to complete the online transaction. This multi-step, multi-device process helps prevent unauthorized access since it is unlikely a hacker would have simultaneous access to the computing device on which the user is performing the online transaction (e.g., the computing device executing browser 402) and the secondary computing device to which OTP 410 was transmitted. However, this adds complexity to the user, in that the user not only has to log into the computing device and HelpingYouPay, but additionally log into the secondary computing device, retrieve the OTP, and manually enter the OTP into the corresponding field of HelpingYouPay. These additional steps, whether performed individually or repeatedly, can cause frustrations to the user.

This added complexity also applies to other forms of online transactions. Consider now FIG. 4b, in which a user is logging into an email account via a browser. Here, website MyEmail displays a first user interface 414 that enables a user to enter a username 416 (illustrated here in the form of an email address), and a corresponding password 418, as a form of authentication used to allow access to a corresponding account. However, to protect the account and its contents, MyEmail has added a multi-step, multi-device security protection process to prevent unintended access. Similar to HelpingYouPay in FIG. 4a, MyEmail transmits a verification code to a secondary computing device of the user. In other words, the user performs a first step of authentication by providing a matching username and password. Upon the user submitting this authentication by activating Sign In control 420, MyEmail sends a verification code to the secondary computing device and transitions to a second user interface 422. Here, the second user interface 422 includes a field 424 for the user to enter the verification code received on the secondary computing device and a completion control 426 to finish the sign-in process. Once the user has manually entered the verification code, and activated the completion control, they have access to their email account. Similar to that described with HelpingYouPay, this multi-step process adds extra protection from unintended access to the email account, but at the expense of added complexity to the user. When a user repeatedly signs into a corresponding account, or repeatedly authorizes online payment transactions, these extra steps can become cumbersome. Thus, it is desirable to simplify or unburden the user from these extra steps, while retaining the extra security provided by a multi-step, multi-device authentication process.

Various embodiments dynamically transfer authentication information between devices to facilitate a multi-step, multi-device authentication procedure. A first computing device establishes a first communication link with a second computing device, and a second communication link with a remote computing device. For example, in some embodiments, the first computing device establishes a first communication link with a mobile device using Bluetooth™, and a second communication link with a remote web server using an Internet-based communication link. However, any other suitable type of communication link can be established between varying combinations of computing devices. When the first computing device accesses the remote computing device via the second communication link, the remote computing device sometimes requests multiple forms of authentication information in order to grant access. In some embodiments, the remote computing device transmits a portion of the requested authentication information to the second computing device. In turn, the first computing device queries the second computing device for the portion of the authentication information using the first communication link. Before sending the portion of authentication information to the first computing device, the second computing device can request user credentials as a way to validate the request for the portion of authentication information. Responsive to validating the user credentials, the second computing device transmits the portion of authentication information to the first computing device over the first communication link.

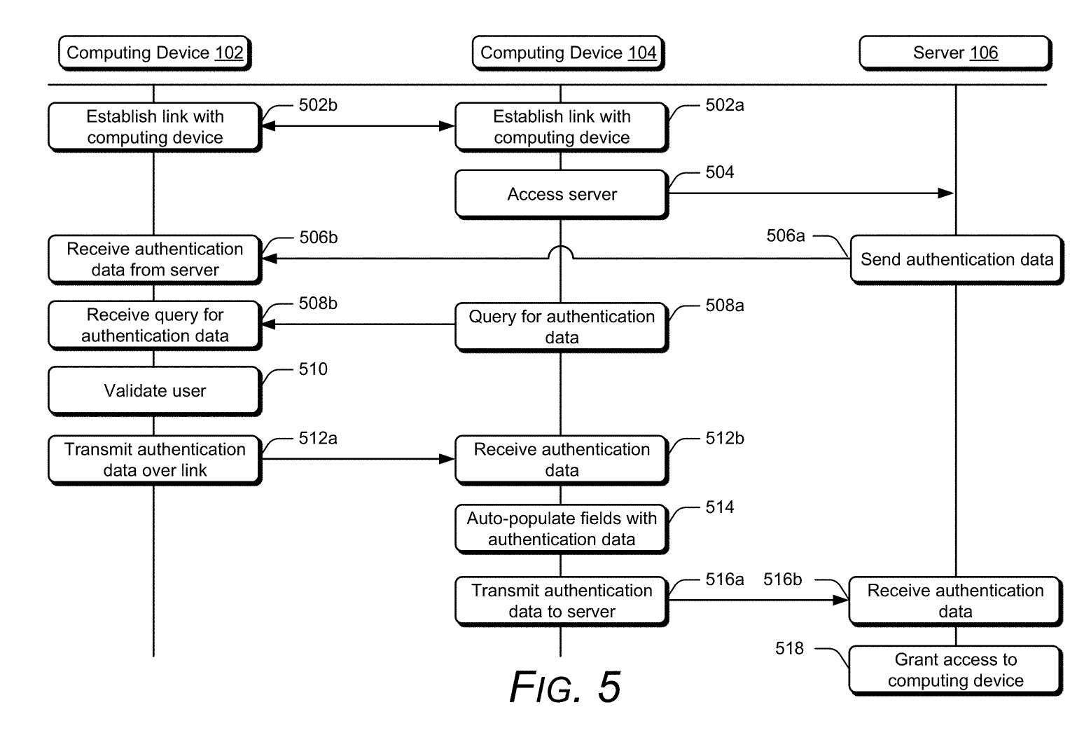

Consider FIG. 5 that illustrates a method of dynamic transfer of authentication data between devices in accordance with one or more embodiments. The method can be performed by any suitable combination of hardware, software, and/or firmware. In at least some embodiments, aspects of the method can be implemented by one or more suitably configured hardware components and/or software modules, such host trust engine module 118, slave trust engine module 120, and/or authentication sensor 124 of FIG. 1. While the method described in FIG. 5 illustrates these steps in a particular order, it is to be appreciated that any specific order or hierarchy of the steps described here is used to illustrate an example of a sample approach. Other approaches may be used that rearrange the ordering of these steps. Thus, the order steps described here may be rearranged, and the illustrated ordering of these steps is not intended to be limiting.

FIG. 5 illustrates the interactions between three devices: computing device 102, computing device 104, and server 106. Each device has a respective timeline directly beneath it that captures various functionality provided by that device. Thus, the vertical line directly beneath computing device 102 corresponds to its respective functionality, the vertical line directly beneath computing device 104 corresponds to its respective functionality, and the vertical line beneath the server 106 a corresponds to its respective functionality. In some cases, two devices share a same designator number that is differentiated by a letter (e.g., XXXa versus XXXb). In these instances, the shared designator number indicates a relationship between the corresponding functionality and/or devices, such as a message exchange between devices.

At step 502a, computing device 104 establishes a communication link with computing device 102. Similarly, at step 502b, computing device 102 establishes a communication link with computing device 104. The communication link can be any suitable type communication link, ranging from a Bluetooth™ wireless communication link, a WLAN communication link, a communication link over a cable connected between the devices, a cellular communication link, and so forth. In some embodiments, the communication link is a direct and/or local communication link in which communications are routed directly between the devices and/or without accessing a broader communication network (e.g., the Internet). Some communication links are automatically established, where one of two computing devices advertises its presence, and the reciprocal device automatically establishes the connection once it moves within range close enough to detect the presence advertisement. For other communication links, a user manually establishes a communication link by interacting with the devices to initiate the connection process. In some cases, the communication link is conditionally established based upon on each of the devices involved having complimentary software components that synchronize the devices with designated handshaking, such as host trust engine module 118 and slave trust engine module 120 of FIG. 1.

At a later point in time, computing device 104 accesses server 106 at step 504. Here, the phrase “access” is used to illustrate any suitable type of access or transaction between the devices, whether the access originates from computing device 104 to server 106, or originates from server 106 to computing device 104. Thus, the access can be a bi-directional exchange of data and/or requests. While illustrated here as occurring after step 502a and step 502b, it is to be appreciated that in other embodiments, computing device 104 accesses server 106 prior to establishing a communication link with computing device 102. Computing device 104 accesses server 106 in any suitable manner. For instance, in some embodiments, computing device 104 accesses a website hosted by server 106 to log into a corresponding account, such as a user logging on to an email account as illustrated in FIG. 4b. In other embodiments, computing device 104 accesses server 106 to authorize an online payment and/or online transaction as illustrated in FIG. 4a. Thus, computing device 104 accessing server 106 represents any suitable type of interaction between the devices.

At step 506a, server 106 sends authentication data to computing device 102. Similarly, at step 506b, computing device 102 receives authentication data from server 106. This can be performed in any suitable manner. For example, in some embodiments, server 106 automatically sends authentication data to computing device 102 in response to an attempt to log into a user profile and/or after a successful login to the user profile via a username and password. Alternately or additionally, server 106 automatically sends authentication data in response to a request to perform an online transaction with a third-party, such as a payment transfer. In other embodiments, server 106 prompts a user to confirm when to send the authentication data. The authentication data can be any suitable type of data, such as an OTP with any suitable combination of alphanumeric characters, where the server automatically generates a new OTP each time it sends authentication data to a secondary computing device (e.g., computing device 102). To determine where to send the authentication data, some embodiments acquire a destination address and/or a destination telephone number from a corresponding user profile associated with a website hosted by server 106. Further, the authentication data can be transmitted via any suitable type of electronic message, such as an email, an SMS message, an instant message, and so forth.

At step 508a, computing device 104 queries computing device 102 for the authentication data. Similarly, at step 508b, computing device 102 receives the query for the authentication data. This can happen automatically and without user-intervention, where computing device 104 automatically transmits the query based upon knowledge acquired during establishing the communication link step 502a and step 502b. Alternately or additionally, a user initiates sending the query. For instance, in various embodiments computing device 104 displays a prompt for a user to confirm querying the mobile device for the authentication information, then receives input that confirms to send a query request, what communication link to use for the query request, what destination address to send the query request to, and so forth. Thus, sending the query can be automated or user-initiated.

Responsive to receiving a query for authentication data, computing device 102 validates a user at step 510. For example, some embodiments validate the user through biometric credentials, such as a fingerprint scan. In one example, computing device 102 displays an indication to a user that authentication data has been received, and/or displays a prompt requesting user credentials to confirm it is acceptable for computing device 102 to send the authentication data. In the case of using a fingerprint scan as a biometric credential, the user would then place a finger on a physical scanner to validate their identity. However, other forms of validation can be utilized as well, such as manually entering a passcode and/or password, biometric credentials via an eye scan, and so forth. By receiving valid user credentials, computing device 102 obtains confirmation that it is safe or acceptable to transfer the authentication data to computing device 104. By transferring the authentication data upon receiving valid user credentials, computing device 102 offloads some of the additional complexity added by the multi-step multi-device process by transferring authentication data between devices for the user, rather than the user manually transferring the authentication data. To transfer the authentication data between devices, the user simply needs to enter valid user credentials, such as by placing a finger on a fingerprint scanner, thus simplifying the process in a straight forward, one step process as perceived from the user's perspective. Accordingly, responsive to validating the user and/or receiving valid user credentials, computing device 102 transmits the authentication data over the communication link at step 512a. In some embodiments, computing device 102 automatically transmits the authentication data, while in other embodiments, computing device 102 waits to receiving input from a user that indicates to transmit the authentication data. For instance, some embodiments display a prompt on computing device 102 to receive confirmation from the user that it is OK to transmit the authentication data. In turn, at step 512b, computing device 104 receives the authentication data over the communication link.

At step 514, computing device 104 auto-populates various data fields with the authentication data. Auto-populating fields not only offloads from the user performing one of the steps in the multi-step, multi-device process, but it can additionally increase the reliability of the authentication data being properly entered. For example, if a user manually copies authentication data from computing device 102, and manually enters the authentication data into computing device 104, this process becomes more prone or susceptible to error than a computer-implemented process, since a user is more likely to make errors than a computer-implemented process. The auto-populating process can be performed in any suitable manner. For example, with respect to FIG. 4a, computing device 104 can auto-populate field 412 with the corresponding authentication data received from computing device 102. As another example, with respect to FIG. 4b, computing device 104 can auto-populate field 424 with the corresponding authentication data. In each example, auto-populating the entry fields reduces the number of actions performed by a user, and additionally increases the likelihood of accuracy of the entered data by reducing user interaction.

After auto-populating fields with authentication data, computing device 104 transmits the authentication data to server 106 at step 516a. In turn, server 106 receives the authentication data at step 516b. In some embodiments, computing device 104 transmits the data after receiving input and/or confirmation from the user to transmit the data. This can include the user activating a selectable control, such as completion control 426 of FIG. 4b. The authentication data can be transmitted over any suitable communication network in with any suitable message formatting and/or protocol handshaking, examples of which are provided herein.

Upon receiving the authentication data, server 106 grants access to computing device at step 518. Here, granting access includes granting access to a user account as well as granting access to transfer funds as further described herein.

The automatic transfer of authentication information provides the user with a simplified solution to a multi-step, multi-device authentication process. Instead of performing multiple manual steps to transfer the data from one device to another, a user can simply provide valid user credentials. In some cases, the user can provide credentials by placing a finger on a FPS. This not only simplifies the process for the user when the data is automatically transferred between devices, but additionally increases the accuracy of data when the receiving device auto-populates fields with the data by reducing and/or eliminating user error.

Having described an example of dynamic transfer of authentication data between devices, consider now of secure storage and transfer of user information between devices in accordance with one or more embodiments.

Secure Storage and Transfer of User Information Between Devices

Consider again FIG. 4a in which a user employs a third-party website to obscure sensitive user information from other websites in an online transaction. Recall that in this example, a user has created a user profile with the website HelpingYouPay, and has additionally entered sensitive user information (e.g., financial information, banking information, and so forth). While HelpingYouPay provides the user with a way to obscure sensitive user information from other websites, there is still an inherent risk to the user. More particularly, the user stores sensitive information at a remote server associated with HelpingYouPay. This inherently implies the user has trust in HelpingYouPay to provide the appropriate security measures to protect this information, and prevent hackers from accessing it. In such a scenario, where the user employs a third-party payment website to store and obscure sensitive user information, the user has no control over how and what security measures are used to protect their data. Since it may be widely known that such websites store sensitive user information, hackers may choose to target these over other websites. Thus, the remote nature where the sensitive user information is stored can contribute to a user feeling insecure about how well it is protected.

Various embodiments provide secure transfer of user information between devices. In some embodiments, a first computing device includes a local database that stores user information, such as financial information. A second computing device, connected to the first computing device via a communication link, queries the first computing device over the communication link for user information. In response to the query, some embodiments display a prompt on the first computing device asking to validate the query for the user information, such as a prompt for user credentials. Responsive to receiving valid user credentials, the first computing device displays a user interface to allow access to user information stored on the local database. For example, in some embodiments, the user interface includes selectable controls that enable a user to navigate the local database and/or select a particular set of user information. Upon identifying the particular set of user information, some embodiments transmit the particular set of user information to the second computing device. In turn, the second computing device auto-populates fields of a user interface to unburden the user from manually entering the user information into the fields.

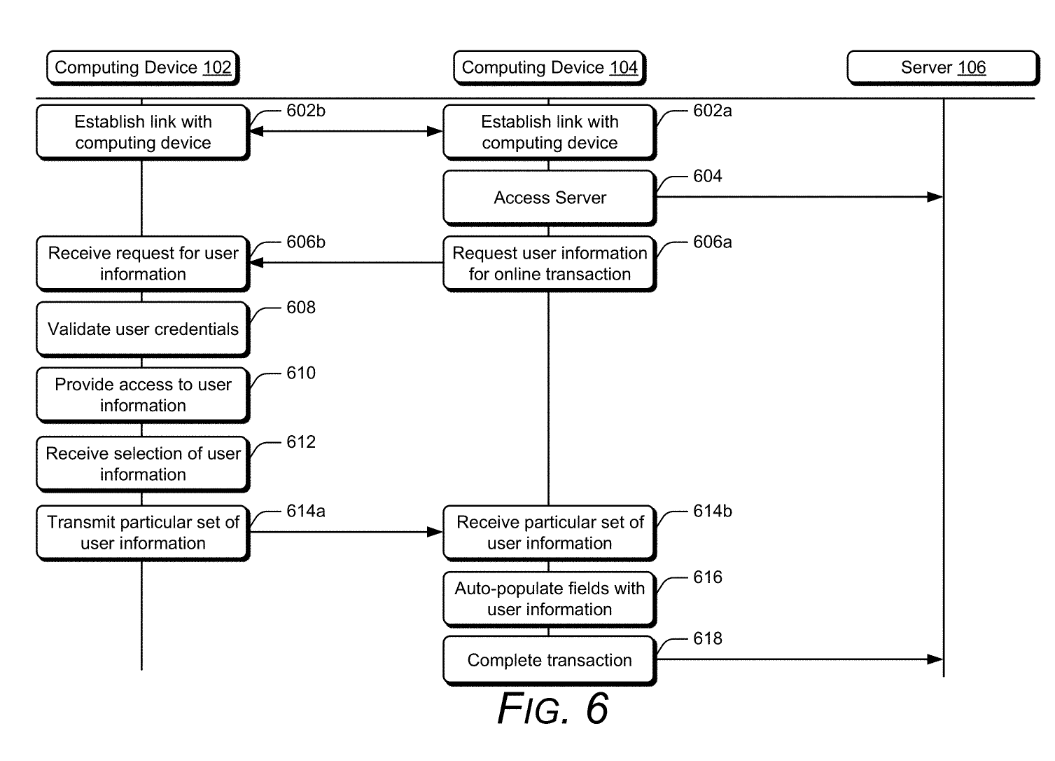

Consider FIG. 6 that illustrates a method of secure transfer of user information between devices in accordance with one or more embodiments. The method can be performed by any suitable hardware, software, firmware, or combination thereof. In at least some embodiments, aspects of the method can be implemented by one or more suitably configured hardware components and/or software modules, such host trust engine module 118, slave trust engine module 120, and/or authentication sensor 124 of FIG. 1. While the method described in FIG. 6 illustrates these steps in a particular order, it is to be appreciated that any specific order or hierarchy of the steps described here is used to illustrate an example of a sample approach. Other approaches may be used that rearrange the ordering of these steps. Thus, the order steps described here may be rearranged, and the illustrated ordering of these steps is not intended to be limiting.

FIG. 6 illustrates the interactions between three devices: computing device 102, computing device 104, and server 106. Each device has a respective timeline directly beneath it that captures various functionality provided by that device. Thus, the vertical line directly beneath computing device 102 corresponds to its respective functionality, the vertical line directly beneath computing device 104 corresponds to its respective functionality, and the vertical line beneath the server 106 corresponds to its respective functionality. In some cases, two devices share a same designator number that is differentiated by a letter (e.g., XXXa versus XXXb). In these instances, the shared designator number indicates a relationship between the corresponding functionality and/or devices, such as a message exchange between devices.

At step 602a, computing device 104 establishes a communication link with computing device 102. Similarly, at step 602b, computing device 102 establishes a communication link with computing device 104. The communication link can be any suitable type communication link, ranging from a Bluetooth™ wireless communication link, a WLAN communication link, a communication link over a cable connected between the devices, and so forth. In some embodiments, the communication link is a direct and/or local communication link in which communications are routed directly between the devices and/or without accessing a broader communication network (e.g., the Internet). Some communication links are automatically established, where one of two computing devices advertises its presence, and the reciprocal device automatically establishes the connection once it moves within range close enough to detect the presence advertisement. For other communication links, a user manually establishes a communication link by interacting with the devices to initiate the connection process. In some cases, the communication link is conditionally established based upon on each of the devices involved having complimentary software components that synchronize the devices with designated handshaking, such as host trust engine module 118 and slave trust engine module 120 of FIG. 1.

At step 604, computing device 104 accesses server 106. Here, the phrase “access” is used to illustrate any suitable type of access or transaction between the devices, whether the access originates from computing device 104 to server 106, or originates from server 106 to computing device 104. Thus, the access can be a bi-directional exchange of data and/or requests. As one non-limiting example of access, computing device 104 accesses server 106 via a website hosted by the server, such as MakeAPurchase of FIG. 4a. While navigating a website, a user may decide to perform an online transaction, such as exchanging payment information in order to facilitate a purchase transaction. Thus, in some embodiments, the website requests user information (e.g., financial or payment information) to perform an online transaction.

Recalling that third-party websites, such as HelpingYouPay, can be a target of hackers, the user here has chosen to store user information on a secondary computing device (e.g., computing device 102) instead of a third-party website. Since computing device 104 and computing device 102 have established a link in step 602a and step 602b, some embodiments of computing device 104 are aware that computing device 102 stores the requested user information. Accordingly, at step 606a, computing device 104 requests user information from computing device 102 for an online transaction with server 106. In some embodiments, computing device 104 transmits the request over the communication link established in step 602a and step 602b. The request can include any suitable type of information, such as a monetary amount, an identification of server 106 and/or a corresponding website, a username and password, and so forth. In turn, at step 606b, computing device 102 receives the request for user information from computing device 104.

As discussed herein, computing device 102 includes a local database on which the user information is stored. However, some embodiments of computing device 102 gate access to the user information and/or the local database based upon valid user credentials. Thus, computing device 102 validates whether the user credentials are permitted access the local database at step 608. This can be achieved in any suitable manner, such as through validating biometric credentials received via authentication sensor 124 of FIG. 1. In the case where authentication sensor 124 uses an FPS, user credentials are received by the user placing a finger on the corresponding sensor. This can be advantageous, since the user performs one action to gain access to the user information: placing their finger on a sensor.

At step 610, and responsive to validating the user credentials permit access, computing device 102 provides access to the user information. In some embodiments, computing device 102 displays a user interface to provide access, as further described herein. In turn, a user navigates through the user information stored on the local database by interacting with the user interface. When the user identifies a particular set of user information they wish to select, the user interface can additionally provide interactive controls to enable selection of a particular set of user information. Accordingly, at step 612, computing device 102 receives selection of the particular set of user information.

At step 614a, computing device 102 transmits the particular set of user information to computing device 104. This can be user-initiated, where the user activates a selectable control to transfer the selected user information. Alternately or additionally, computing device 104 automatically transmits the particular set of user information when input is received that makes the selection. In turn, computing device 104 receives the particular set of user information at step 614b. In some embodiments, computing device 102 transmits the selected user information over the communication link established in step 602a and step 602b.

At step 616, computing device 104 auto-populates fields with the particular set of user information. For example, referring back to MakeAPurchase, a website participating in an online transaction can include one or more fields used to submit payment information. When computing device 104 auto-populates these fields with the particular set of user information received from computing device 102, computing device 104 not only offloads the user from manually entering this information, but also reduces the probability of user input error. Accordingly, at step 618, computing device 104 completes the transaction by submitting the particular set of user information to server 106. This can be performed automatically when the fields or auto-populated, or can be performed in response to receiving user input to submit data to server 106.

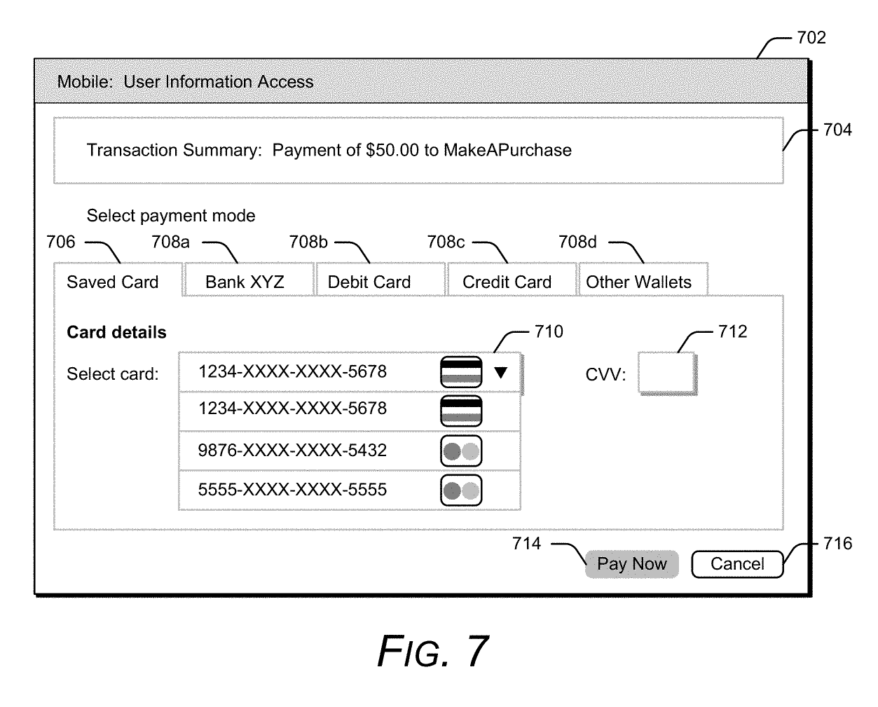

FIG. 7 illustrates an example user interface 702 displayed to enable access to user information stored on a local database. In some embodiments, computing device 102 of FIG. 1 displays user interface 702 in response to receiving a request for user information from a second computing device, such as computing device 104 of FIG. 1. However, in other embodiments, computing device 102 displays user interface 702 in response to a user request to access, update, edit, or reconfigure user information stored in the local database. Some embodiments implement user interface 702 via slave trust engine module 120 of FIG. 1 and/or user interface module 210 of FIG. 2.

To further illustrate access to user information stored on a local database, consider again the example in which a user decides to perform an online transaction with a website, such as website MakeAPurchase of FIG. 4a. For any number of reasons, the user has logged onto the website via a host computing device (e.g., computing device 104). Here, the phrase “host” is used to indicate the user computing device on which an online transaction occurs. However, instead of using a third-party payment web site to provide payment information, the user has chosen access user information stored on a local database of a secondary computing device (e.g., computing device 102). When the two computing device are coupled via a communication link, the primary computing device sends a request to the secondary computing device for user information, and the secondary computing device validates the user before providing access to the user information, such as through receiving user credentials via an FPS as further described herein. In other embodiments, the user can activate user interface 702 manually, such as through selection of an icon. When the secondary computing device receives valid user credentials, it displays user interface 702 to provide the access.

In some embodiments, user interface 702 includes a summary region 704 to provide the user with information about an online transaction. For example, the request from computing device 104 can include information about the online transaction, which is subsequently displayed in summary region 704. Here, summary region 704 includes an identification of the website involved in the online transaction, and a monetary amount associated with the online transaction. This summary region can be used by a user to visually verify what online transaction will be using the selected user information and/or which website will be receiving the user information. However, any other suitable type of information can be included in the summary, and/or received in the request for user information. In other embodiments, user interface 702 omits summary region 704 and/or does not display a summary of the online transaction.

To enable navigation of user information stored in the local database, user interface 702 includes selectable tab 706 which represents the active tab that has the primary focus. In other words, tab 706 is the currently selected tab. User interface 702 includes other selectable tabs as well: tab 708a, tab 708b, tab 708c, and tab 708d. When a user selects a respective tab, the information presented related to a respective set of user information. For instance, tab 708a presents user information associated with Bank XYZ, tab 708b presents user information associated with Debit Card, tab 708c presents user information associated with Credit Card, and tab 708d presents user information associated with Other Wallets. Thus, as a user selects a different tab, they are able to navigate through the user information stored in the local database. However, other forms of navigation can be utilized as well, such as pulldown tabs, file menus, icons, selectable links, radio buttons, text-entry fields, and so forth. Similarly, other types of user information can be represented in a tab or navigated by the user, such as various digital wallets associated with the user and/or other third-party web sites.

Returning to tab 706, the user information corresponding to tab 706 pertains to saved card information. Any suitable type of card information can be stored, such as a credit card, a gift card, and so forth. Here, tab 706 includes a pull-down menu 710 that allows the user to navigate various types of saved cards (and their associated user information), and select a particular card from the various cards. When a particular card is selected from pull down menu 710, it becomes the active or selected user information. In this example, user interface 702 displays partial information of the user information associated with the selected card, and obscures other portions. For instance, instead of fully displaying the user information that corresponds an account number, only portions of the account number are displayed and other portions are replaced with an “X”. This adds protection to the user information in case someone has undesired visibility into user interface 702.

Some embodiments additionally include fields for information manually entered by the user, such as additional antifraud security features. For example, a field 712 is associated with a Card Verification Value (CVV) number. In this example, the user manually enters the CVV data into field 712, but in other embodiments, field 712 can be auto-populated from user information stored on the local database. While described in terms of CVV data, any other suitable type of information can be requested or displayed in field 712, such as a password, a passcode, a user name, and so forth. Thus, user interface 702 can enable selection of user information stored on a corresponding data base and/or request additional information be entered by the user.

To initiate transfer of a particular set of user information, user interface 702 includes selectable control 714. User interface 702 also includes selectable control 714, which can be used to cancel a transaction completely and/or close user interface 702. These selectable controls can be used in any suitable manner. For instance, once the user has completed selecting a particular set of user information, they can activate selectable control 714 transfer the particular set of user information stored on the local database and/or and information manually entered in field 712 to another device (e.g., computing device 104). Conversely, if the user decides to cancel transferring any user information to the other device, they can instead activate selectable control 716. Thus, various embodiments provide a user interface to enable a user to access and navigate through information stored on a local database of a secondary computing device, and additionally transfer this data to another device.

By gating access to user information stored on a local database, computing device 102 provides a user with an option for secure storage that is local to the user. In other words, gating the local database via user credentials can be implemented without accessing external devices, such as Internet-based server or cloud storage. In turn, this provides the user with more control over who can, and cannot, access this data relative to a third-party website since the data is stored locally and within the supervision of the user. The automated transfer of user information, when selected, additionally offloads the user from performing these tasks manually, and increases the accuracy of entering data when it is auto-populated into fields by reducing and/or eliminating user error in the entering process.

Having described an example secure transfer of user information between devices, consider now a discussion of example devices in which various embodiments can be implemented.

Example Devices

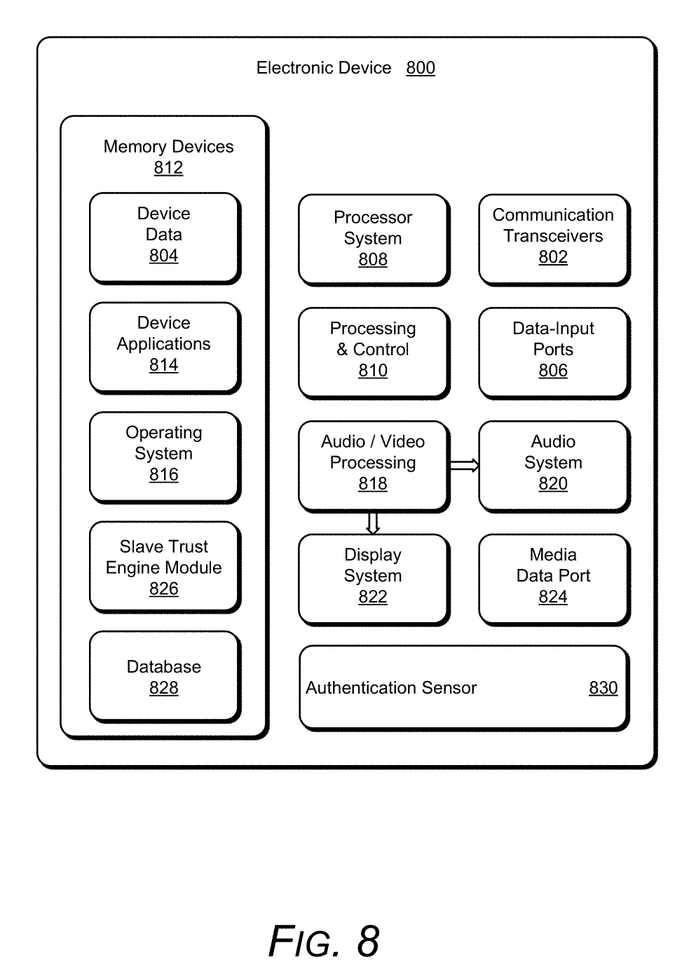

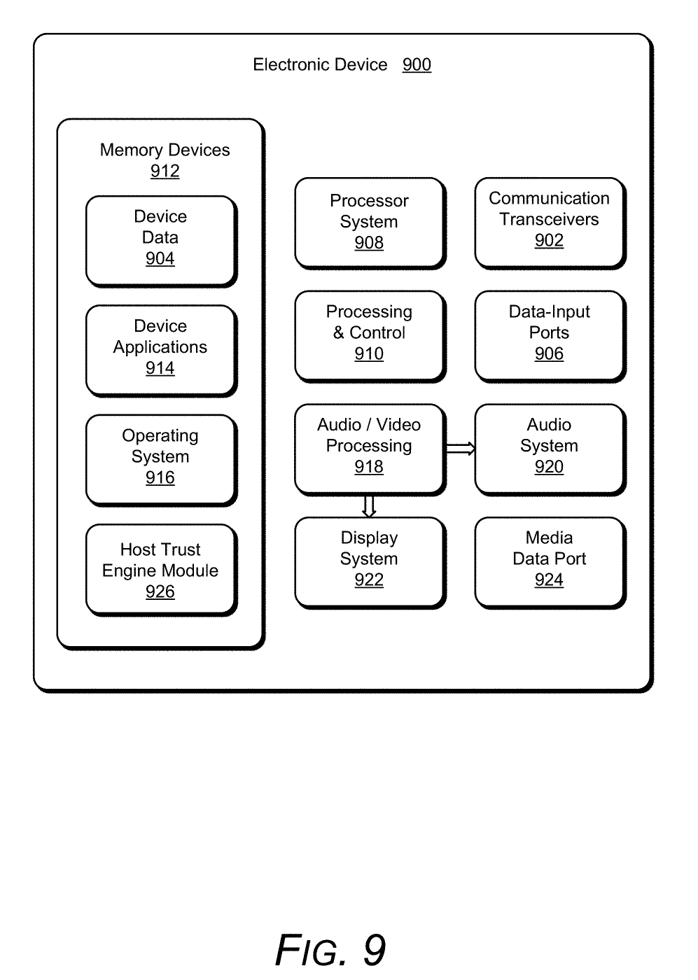

FIG. 8 illustrates various components of an example first electronic device 800 (such as computing device 102 of FIG. 1), while FIG. 9 illustrates various components of a second computing device (such as computing device 104 of FIG. 1), each of which can be utilized to implement the embodiments described herein. In some embodiments, electronic device 800 and electronic device 900 have at least some similar components. Accordingly, for the purposes of brevity, FIG. 8 and FIG. 9 will be described together. Similar components associated with FIG. 8 will be identified as components having a naming convention of “8XX”, while components associated with FIG. 9 will be identified as components having a naming convention of “9XX”. Conversely, components unique to each device will be described separately and after the similar components. Electronic device 800 and electronic device 900 can be, or include, many different types of devices capable of implementing automatic transfer of authentication information and secure transfer of user information in accordance with one or more embodiments.

Electronic device 800/electronic device 900 includes communication transceivers 802/communication transceivers 902 that enable wired or wireless communication of device data 804/device data 904, such as received data and transmitted data. While referred to as a transceiver, it is to be appreciated that communication transceivers 802/communication transceivers 902 can additionally include separate transmit antennas and receive antennas without departing from the scope of the claimed subject matter. Example communication transceivers include Wireless Personal Area Network (WPAN) radios compliant with various Institute of Electrical and Electronics Engineers (IEEE) 802.15 (Bluetooth™) standards, Wireless Local Area Network (WLAN) radios compliant with any of the various IEEE 802.11 (WiFi™) standards, Wireless Wide Area Network (WWAN) radios for cellular telephony (3GPP-compliant), wireless metropolitan area network radios compliant with various IEEE 802.16 (WiMAX™) standards, and wired Local Area Network (LAN) Ethernet transceivers.

Electronic device 800/electronic device 900 may also include one or more data-input ports 806/data-input ports 906 via which any type of data, media content, and inputs can be received, such as user-selectable inputs, messages, music, television content, recorded video content, and any other type of audio, video, or image data received from any content or data source. Data-input ports 806/data-input ports 906 may include Universal Serial Bus (USB) ports, coaxial-cable ports, and other serial or parallel connectors (including internal connectors) for flash memory, Digital Versatile Discs (DVDs), Compact Disks (CDs), and the like. These data-input ports may be used to couple the electronic device to components, peripherals, or accessories such as keyboards, microphones, or cameras.

Electronic device 800/electronic device 900 of this example includes processor system 808/processor system 908 (e.g., any of application processors, microprocessors, digital-signal processors, controllers, and the like) or a processor and memory system (e.g., implemented in a system-on-chip), which processes computer-executable instructions to control operation of the device. A processing system may be implemented at least partially in hardware, which can include components of an integrated circuit or on-chip system, digital-signal processor, application-specific integrated circuit, field-programmable gate array, a complex programmable logic device, and other implementations in silicon and other hardware. Alternatively, or in addition, the electronic device can be implemented with any one or combination of software, hardware, firmware, or fixed-logic circuitry that is implemented in connection with processing and control circuits, which are generally identified as processing and control 810/processing and control 910. Although not shown, electronic device 800/electronic device 900 can include a system bus, crossbar, interlink, or data-transfer system that couples the various components within the device. A system bus can include any one or combination of different bus structures, such as a memory bus or memory controller, data protocol/format converter, a peripheral bus, a universal serial bus, a processor bus, or local bus that utilizes any of a variety of bus architectures.

Electronic device 800/electronic device 900 also includes one or more memory devices 812/memory devices 912 that enable data storage, examples of which include random access memory (RAM), non-volatile memory (e.g., read-only memory (ROM), flash memory, EPROM, EEPROM, etc.), and a disk storage device. Memory devices 812/memory devices 912 are implemented at least in part as a physical device that stores information (e.g., digital or analog values) in storage media, which does not include propagating signals or waveforms. The storage media may be implemented as any suitable types of media such as electronic, magnetic, optic, mechanical, quantum, atomic, and so on. Memory devices 812/memory devices 912 provide data storage mechanisms to store the device data 804/device data 904, other types of information or data, and various device applications 81⁴/ₐpplications 914 (e.g., software applications). For example, operating system 816/system 916 can be maintained as software instructions within memory devices 812/memory devices 912 and executed by processor system 808/processor system 908.

Electronic device 800/electronic device 900 also includes audio and video processing system 818/processing system 918 that processes audio data and passes through the audio and video data to audio system 820/audio system 920 and to display system 822/display system 922. Audio system 820/audio system 920 and display system 822/display system 922 may include any modules that process, display, or otherwise render audio, video, display, or image data. Display data and audio signals can be communicated to an audio component and to a display component via a radio-frequency link, S-video link, HDMI, composite-video link, component-video link, digital video interface, analog-audio connection, or other similar communication link, such as media-data port 824/media-data port 924. In some implementations, audio system 820/audio system 920 and display system 822/display system 922 are external components to electronic device 800/electronic device 900. Alternatively, or additionally, display system 822/display system 922 can be an integrated component of the example electronic device, such as part of an integrated display and touch interface.

With respect to electronic device 800, in some aspects, memory devices 812 includes slave trust engine module 826 and database 828. Among other things, slave trust engine module 826 synchronizes communications with an external device, such as electronic device 900 of FIG. 9. Alternately or additionally, slave trust engine module 826 receives incoming communications from the external device, and determines a response to the communications. In some cases, slave trust engine module 826 manages access to data stored on electronic device based, such as database 828. Database 828 represents secure storage on computing device 800. In some embodiments, database 828 includes multiple different types of user information, examples of which are provided herein. Electronic device 800 also includes authentication sensor 830 that represents functionality for authenticating credentials and/or authentication of a user. In some embodiments, authentication sensor 830 includes hardware sensors that gather data used to validate user credentials, such as a fingerprint sensor. While described in the context of a hardware sensor, it is to be appreciated that authentication sensor 830 can alternately or additionally include software, firmware, hardware, or any combination thereof.

With respect to electronic device 900, in some aspects, memory devices 912 includes host trust engine module 926. Among other things, host trust engine module 926 represents functionality used to synchronize communications and/or exchange data with an external device, such as electronic device 800 of FIG. 8. Some embodiments of host trust engine module 926 request data from the external device and, upon receiving the requested data, auto-populate fields of a user interface to offload a user from manually entering the data into the fields.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method comprising:
establishing, using a computing device, a first communication link with a secondary computing device;
accessing, using the computing device, a remote computing device;
receiving, at the computing device and from the remote computing device over a second communication link, a request for authentication information to gain access to the remote computing device;
querying, using the first communication link, the secondary computing device for the authentication information;
receiving, over the first communication link, the authentication information from the secondary computing device;
auto-populating one or more fields of a user interface displayed on the computing device with the authentication information; and
transmitting the authentication information to the remote computing device to gain access to the remote computing device.

2. The method as recited in claim 1, wherein the authentication information comprises a One-Time Password (OTP).

3. The method as recited in claim 1, wherein accessing the remote computing device comprises participating in an online transaction.

4. The method as recited in claim 3, wherein accessing the remote computing device further comprises accessing a third-party payment website hosted by the remote computing device.

5. The method as recited in claim 4, wherein the online transaction comprises a payment transaction via the third-party payment website.

6. The method as recited in claim 1, wherein accessing the remote computing device comprises logging into a user account associated with the remote computing device.

7. The method as recited in claim 1, wherein establishing the first communication link comprises establishing a Bluetooth communication link.

8. The method as recited in claim 1, wherein querying the secondary computing device for the authentication information further comprises:
displaying a prompt to confirm querying the secondary computing device for the authentication;
receiving input associated with confirming the prompt; and
responsive to receiving the input, performing the querying the secondary computing device for the authentication information.

9. The method as recited in claim 1, wherein establishing the first communication link with the secondary computing device further comprises establishing the first communication link with a mobile device.

10. A method comprising:
establishing, using a mobile device, a first communication link with a first computing device;
receiving, from a second computing device over a second communication link, authentication information associated with the second computing device;
receiving, from the first computing device and over the first communication link, a request for the authentication information associated with the second computing device;
querying, using the mobile device, for user credentials;
responsive to receiving the user credentials, validating, using the mobile device, the user credentials, and
responsive to validating the user credentials, automatically transmitting, over the first communication link, the authentication information to the first computing device.

11. The method as recited in claim 10, wherein the authentication information comprises a One-Time Password (OTP).

12. The method as recited in claim 10, wherein querying for the user credentials further comprises querying for biometric credentials.

13. The method as recited in claim 12, wherein the biometric credentials comprise a fingerprint associated with a known user.

14. The method as recited in claim 10, wherein establishing the first communication link comprises establishing a Bluetooth communication link.

15. The method as recited in claim 10, wherein the second computing device comprises a remote server hosting a website.

16. The method as recited in claim 10, wherein receiving the authentication information further comprises receiving the authentication information over an Internet-based communication link.

17. A computing device comprising:
an authentication sensor;
one or more processors; and
one or more computer-readable memory storage devices comprising processor executable instructions which, responsive to execution by the one or more processors, work in concert with the authentication sensor to enable the device to perform operations comprising:
establishing a local communication link with a first external device;
receiving authentication information over an Internet-based communication link from a second external device;
receiving, over the local communication link, a query from the first external device for the authentication information;
authenticating, using the authentication sensor, user credentials associated with the computing device to determine if the user credentials are valid; and
responsive to authenticating the user credentials as valid, transmitting, over the local communication link and to the first external device, the authentication information.

18. The computing device as recited in claim 17, wherein the authentication sensor comprises a fingerprint sensor.

19. The computing device as recited in claim 17, wherein transmitting the authentication information further comprises automatically transmitting the authentication information in response to authenticating the user credentials as valid.

20. The computing device as recited in claim 17, wherein the user credentials comprise biometric credentials.
